(19) United States
(12) Patent Application Publication
(10) Pub. No.: US 2023/0291152 A1
(43) Pub. Date: Sep. 14, 2023

(54) CONNECTOR FOR RF TRANSMISSION

(71) Applicant: CONEXTIVITY GROUP SA, St-Prex (CH)

(72) Inventors: Valentine FAVROD, Lonay (CH); Thierry GOLDHORN, Gland (CH); Jean-Marie BUCHILLY, Eclagnens (CH)

(21) Appl. No.: 18/019,759

(22) PCT Filed: Sep. 29, 2021
(86) PCT No.: PCT/IB2021/058879

§ 371 Date: Feb. 3, 2023

(30) Foreign Application Priority Data
Sep. 29, 2020 (WO) PCT/IB2020/059100

(51) Int. Cl. H01R 13/646; H01R 13/02; B33Y 80/00

(52) U.S. Cl. CPC H01R 13/646; H01R 13/025; B33Y 80/00; H01R 43/18

(57) ABSTRACT

The invention concerns a connector part, such as a plug or a socket, for a cable, such as a RF cable having specific parameters and/or features, wherein the connector is designed to mimic at least one parameter and/or feature of the cable to minimize the discontinuity in the transmission in the connector.

### CORRESPONDING APPLICATION

The present application claims priority to earlier application N° PCT/IB2020/059100 filed on Sep. 29, 2020 in the name of Fischer Connectors Holding SA, the content of this earlier application being incorporated by reference in its entirety in the present application.

### TECHNICAL FIELD

The present invention concerns the field of connectors, such as electrical connectors.

More specifically, the present invention concerns the field of connectors suitable for the transmission of RF currents.

### BACKGROUND ART

Radio frequency (RF) is the oscillation rate of an alternating electric current. Actually, the demand and need in high frequencies are always increasing considering the world in which we live, with more and more connected devices or products and the need to quickly access the information and data. Although wireless solutions are widely used, cables still play a very important role in the transmission of current and data.

Today the fastest copper cabling solution is the Cat8 Ethernet cable that can transmit up to 2 GHz frequencies. It is designed with twisted pairs 1 of wires and individual shield 2 (for example an Al foil) around each pair 1 of wires and an overall shield 3 that protects all pairs 1 of the cable, these parts being in a jacket 4, as illustrated in FIG. 1.

However, when conducted by a cable, RF currents will reflect from discontinuities in the line and travel back in the cable toward the source. Such discontinuities are typically created by connectors themselves. This phenomenon reduces the quality of the signal transmitted and may even make it impossible to transmit properly some high frequency signals in a connected cable because of the influence of the connectors on the transmitted signal.

Therefore, connectors form a bottleneck in the transmission of signals thereby reducing the performance of the cable, sometimes even making such transmission impossible.

### SUMMARY OF THE INVENTION

An aim of the present invention is therefore to improve the known devices and products, in particular the connectors used in such cables.

More specifically, an aim of the present invention is to provide a connector designed to be as transparent as possible to RF transmission which overcomes the above-mentioned drawbacks of known connectors.

In an embodiment, the invention concerns a connector part, such as a plug or a socket, for a cable, such as a RF cable having specific parameters and/or features, wherein said cable comprises at least a pair of wires and wherein the connector part is designed to mimic at least one parameter and/or feature of the cable to minimize a discontinuity in transmission in the connector.

In embodiments the parameter and/or feature of the cable comprises
a distance between pairs of wires;
a distance between the wires;
a distance between the pair of wires and a shield;
a section (shape and size) of wires and/or of contacts;
an interval of the twist of the wires or pair of wires;
Material, electrical and EM properties of the conductor and the insulation;
a density of the materials and elements,
a shielding of the individual wires and/or pairs of wires and/or entire cable.

In embodiments the connector part is a plug and/or a socket.

In embodiments the connector part comprises a channel.

In embodiments said channel has the shape of a helicoidal spring. Other shapes are of course possible in the context of the present invention, in order to mimic the parameter/feature of the wires.

In embodiments the connector part is combined with a cable.

In embodiments the invention concerns a method to manufacture a connector part, wherein the method uses 3D printing of multiple material to form said connector part and/or contacts of the wires.

In embodiments the method comprises a step of printing conducting twisted contacts and insulating material in-between.

In embodiments of the method, one directly prints the contacts on the cable and or wires that will be inserted in the connector.

In embodiments a twisted contact like a helicoidal spring is manufactured and put in a thermoset to maintain it in shape.

In embodiments a connector part is produced by 3D printing, and wherein said part comprises at least one shaped channel to receive wires in said channels.

In embodiments said channel has the shape of a helicoidal spring. Another equivalent shape is of course possible in the frame of the present invention to achieve de desired goal.

### BRIEF DESCRIPTION OF THE DRAWINGS

FIG. 1 illustrates the principle of a cable suitable for RF transmission described above.

FIG. 2 illustrates the principle of a connector according to the present invention.

FIG. 3 illustrates an embodiment of a connector and cable according to the present invention.

FIG. 4 illustrates an example of a 3D printing machine.

FIG. 5 illustrates an example of a coil end of a wire.

FIG. 6 illustrates an embodiment of a connector part with a channel.

### DETAILED DESCRIPTION OF THE INVENTION

The invention concerns a connector in a transmission line, the transmission line comprising a cable 10 with at least one twisted pair 1 of wires (or conductors) and a couple of connector parts 11, 12 (such as a plug and a socket for example) in the middle as illustrated in FIG. 2.

It is known that some parameters influence the RF transmission and a goal is to maintain these parameters stable throughout the whole transmission line in order to have the best RF transmission possible with no bottleneck, especially in the connector parts 11, 12.

According to embodiments of the present invention, the connector and its parts 11, 12 is designed to mimic some parameters and features of a cable 10 to be transparent in term of RF transmission.

Typically, what is sought is to keep these parameters constant even if the environment changes, for example with a transition between the cable 10 and a connector part 11, 12.

In embodiments, the connector and its parts are hence designed in a way to have the same or equivalent parameters and properties in the connector or parts thereof as in the cable to maintain a continuity in said parameters and/or properties.

As examples, the following parameters/properties of the wires or cable are maintained in the connector or part 11/12 thereof (at least one of them or several of them, or even all of them):
a distance between the pair 1 of wires;
a distance between the wires (conductors);
a distance between the pair 1 of wires and a shield 3;
a section (shape and size) of the conductors and of the contacts, preferably similar if not identical;
an interval of the twist;
Material, electrical and EM properties of the conductor and the insulation are similar if not identical;
density of the materials and elements remain constant.
a Shielding 2, 3 of the individual wires and/or pairs 1 of wires and/or of the entire cable is present.

In addition, in embodiments, the connector is preferably designed to be as short as possible in order to reduce the length of the possible discontinuity.

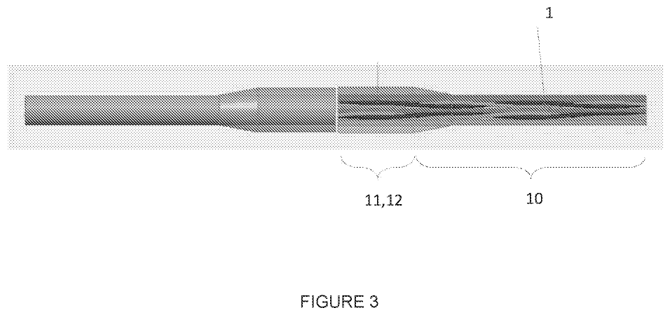

FIG. 3 illustrates an embodiment of a transmission line in the connector according to the present invention. As illustrated in this embodiment, the twisted pair 1 of wires in the cable 10 extends in the connector parts 11, 12 with the same twist interval or step (or at least an equivalent one) to avoid any parameter change. In a broad manner, the design of the twisted pair 1 of wires is kept with the contacts in the connector parts 11, 12.

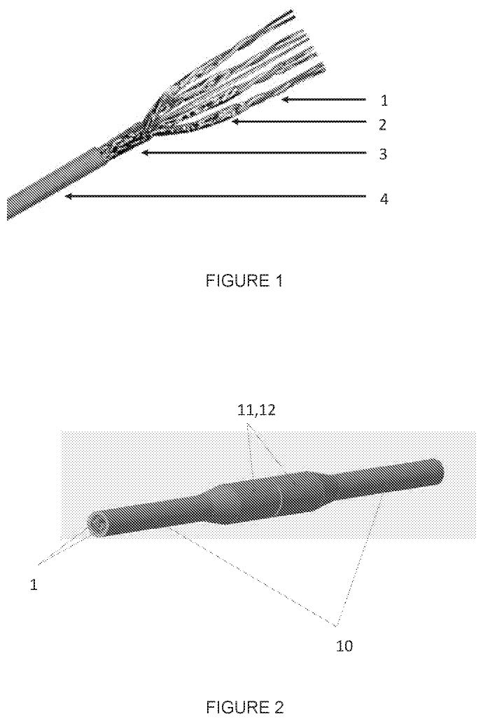

The description above and FIG. 3 show one example of a cable but the principle is applicable for one or more than one twisted pairs of wires (as in the cable of FIG. 1), multiple pairs with different twist intervals, conductors that are not twisted.

In some embodiments, the shielding 2 of the pair 1 may be continued in the connector.

In some embodiments, the shielding 3 of the cable may be kept in the connector.

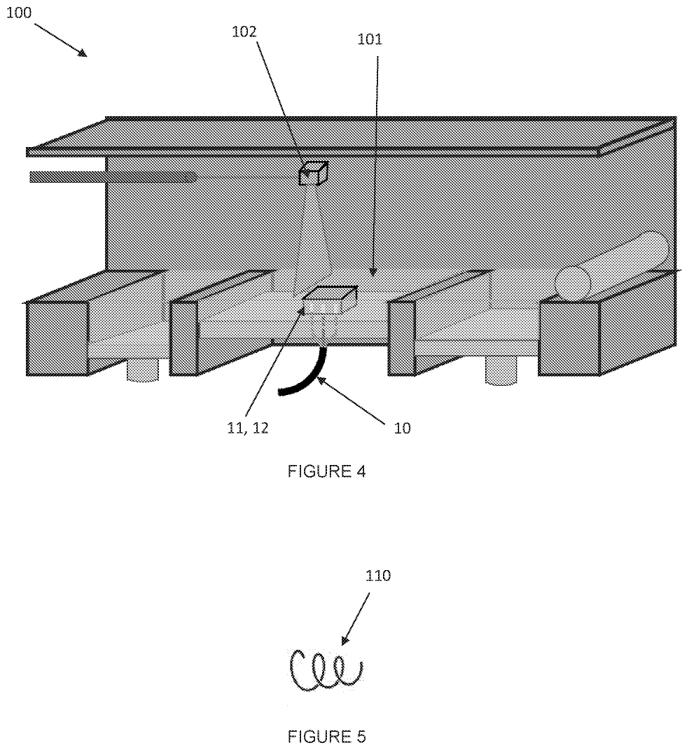

The connector according to the present invention may be manufactured by 3D printing of multiple material. The principle of such a 3D printing machine is illustrated in FIG. 4.

For examine, in one embodiment, the machine 100 applies layers of powder 101 on the wire ends of the cable 1 and a laser 102 is used to harden the successive powder layers and form a connector 11 or 12 with the wires 1 in the connector 11/12.

In another embodiment, the machine 100 could be used to 3D print conducting twisted contacts and insulating material in-between. In embodiments, one may directly print the contacts on the cable 10 (wire ends) that will be inserted in the machine by using the machine 100 illustrated in FIG. 4 and the principle of 3D printing.

In other embodiments, other ways of manufacturing such a connector 11, 12 would be to manufacture a twisted contact like a spring and to put it in a thermoset to maintain it. Such a twisted contact 110 is illustrated in FIG. 5.

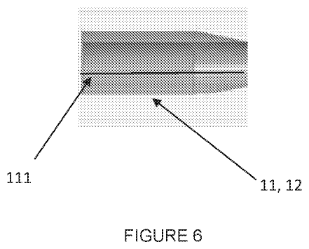

In other embodiments, as illustrated in FIG. 6, an insulating bloc forming a connector 11 and/or 12 may be 3D printed with at least one hollow channel 111 within an insulating material and then a conducting wire 1 may be inserted in the channel 111 to act as a contact. The channel may have any shape (illustrated as a straight line 111 in FIG. 6), for example a helicoidal spring 110 as shown in FIG. 5. The insertion of the wire would therefore shape it with the required twist (for example as in FIG. 5) or another shape in accordance with the principles of the present invention, the aim being to maintain the certain properties of the cable or wire or pairs thereof in the connector and/or in the connector part 11, 12.

The present description is neither intended nor should it be construed as being representative of the full extent and scope of the present invention. The present invention is set forth in various levels of detail herein as well as in the attached drawings and in the detailed description of the invention and no limitation as to the scope of the present invention is intended by either the inclusion or non-inclusion of elements, components, etc. Additional aspects of the present invention have become more readily apparent from the detailed description, particularly when taken together with the drawings.

Moreover, exemplary embodiments have been described to provide an overall understanding of the principles of the structure, function, manufacture, and use of the systems and methods disclosed herein. One or more examples of these embodiments are illustrated in the accompanying drawings. Those skilled in the art will understand that the systems and methods specifically described herein and illustrated in the accompanying drawings are non-limiting exemplary embodiments and that the scope of the present invention is defined not solely by the claims. The features illustrated or described in connection with an exemplary embodiment may be combined with the features of other embodiments. Such modifications and variations are intended to be included within the scope of the present invention. A number of problems with conventional methods and systems are noted herein and the methods and systems disclosed herein may address one or more of these problems. By describing these problems, no admission as to their knowledge in the art is intended. A person having ordinary skill in the art will appreciate that, although certain methods and systems are described herein with respect to embodiments of the present invention, the scope of the present invention is not so limited.

Moreover, while this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the scope of this invention.

1. A connector part (11,12), such as a plug or a socket, for a cable (10), such as a RF cable having specific parameters and/or features, wherein said cable comprises at least a pair (1) of wires and wherein the connector part (11,12) is designed to mimic at least one parameter and/or feature of the cable (10) to minimize a discontinuity in transmission in the connector.

2. The connector part according to claim 1, wherein said parameter of the cable comprises
a distance between the pairs (1) of wires;
a distance between the wires;
a distance between the pair (1) of wires and a shield (2,3);
a section (shape and size) of wires and/or of contacts;
an interval of the twist of the wires or pair of wires;
Material, electrical and EM properties of the conductor and the insulation;
a density of the materials and elements,
a shielding of the individual wires and/or pairs of wires and/or entire cable.

3. The connector part as defined in claim 1, wherein said connector part (11,12) is a plug or a socket.

4. The connector part as defined in claim 1, wherein said connector part comprises a channel (111).

5. The connector part as defined in claim 1, wherein said a channel (111) has the shape of a helicoidal spring (110).

6. The connector part as defined in claim 1, wherein said connector part (11,12) is combined with a cable.

7. A method to manufacture a connector part according to claim 1, wherein the method uses 3D printing of multiple material to form said connector part (11, 12) and/or contacts of the wires.

8. The method as defined in claim 1, comprising the step of printing conducting twisted contacts and insulating material in-between.

9. The method as defined in claim 7, wherein one directly prints the contacts on the cable that will be inserted in the connector.

10. The method as defined in claim 7, wherein a twisted contact like a helicoidal spring is manufactured and put in a thermoset to maintain it in shape.

11. The method as defined in claim 7, wherein a connector part is produced by 3D printing, wherein said part comprises at least one shaped channel to receive wires in said channels.

12. The method as defined in claim 1, wherein said channel has the shape of a helicoidal spring.
